(19) United States
(12) Patent Application Publication
(10) Pub. No.: US 2005/0128368 A1
(43) Pub. Date: Jun. 16, 2005

(54) Liquid crystal projector

(76) Inventors: Katsuhide Aoto, Chiba (JP); Naoki Iwasaki, Mobara (JP); Satoru Kawaai, Saitama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/008,227

(22) Filed: Dec. 10, 2004

(30) Foreign Application Priority Data
Dec. 10, 2003 (JP) 2003-412173

(51) Int. Cl. G02F 1/1335

(52) U.S. Cl. 349/5

(57) ABSTRACT

A liquid crystal projector splits light from a light source into three lights of three different primary colors, respectively, through an optical system, enters the three lights into three liquid crystal display panels corresponding to the three different primary colors, respectively, combines the three lights reflected from the three liquid crystal display panels using a prism, and projects the combined three lights through a first lens onto a screen. The liquid crystal projector is provided with two second lenses each of which is disposed at a respective one of two entrance sides of the prism on which the three reflected lights are incident, and a combination of the two second lenses, the prism and the first lens constitute a projection lens optical system which projects the combined three lights onto the screen.

### CLAIM OF PRIORITY

The present application claims priority from Japanese application serial no. 2003-412173, filed on Dec. 10, 2003, the content of which is hereby incorporated by reference into this application.

### BACKGROUND OF THE INVENTION

The present invention relates to a liquid crystal projector, and in particular to a color liquid crystal projector having an improved optical system.

The color liquid crystal projector is such that white light from one light source is split into three lights of primary colors of red (R), green (G) and blue (B), then the three lights of the primary colors are entered into the red-color, green-color and blue-color liquid crystal display panels, respectively, and then the three lights of the primary colors reflected from the respective liquid crystal display panels are recombined and are projected onto a screen spaced by a distance from the liquid crystal projector via a projection lens.

Conventionally, splitting of light from one light source into plural color lights was performed by means of a polarizing beam splitter or the like, combining of lights of plural colors was performed by means of a dichroic prism or the like, and the lights from the dichroic prism are projected onto a screen via a projection lens (see Japanese Patent Application Laid-Open Nos. 2003-177467 and 2001-318426 publications, for example).

### SUMMARY OF THE INVENTION

Since, in the liquid crystal projector of the above-described configuration, a polarizing beam splitter and a dichroic prism are disposed between the respective liquid crystal display panels and a projection lens, a back focal length of the projection lens needs to be selected to be great, and consequently, there has been a problem in that the projection lens needs to selected to be large in size. Further, a distance between the liquid crystal projector and a screen needs to be made large because of the great back focal length, and this has been preventing the thickness of a rear projection type. TV receiver and the like, for example, from being reduced.

The present invention has been made in view of the above, and it is an object of the present invention to provide a liquid crystal projector capable of reducing the size of the projection lens and its back focal length at the same time.

The following will explain briefly the summary of representative ones of the inventions disclosed in this specification.

In accordance with an embodiment of the present invention, there is provided a liquid crystal projector which splits light from a light source into three lights of three different primary colors, respectively, through an optical system, enters said three lights into three liquid crystal display panels corresponding to said three different primary colors, respectively, combines said three lights reflected from said three liquid crystal display panels using a prism, and projects said combined three lights through a first lens onto a screen, wherein said liquid crystal projector is provided with two second lenses each of which is disposed at a respective one of two entrance sides of said prism on which said three reflected lights are incident, and a combination of said two second lenses, said prism and said first lens constitute a projection lens optical system which projects said combined three lights onto said screen.

In accordance with another embodiment of the present invention, there is provided a liquid crystal projector which splits light from a light source into three lights of three different primary colors, respectively, through an optical system, enters said three lights into three liquid crystal display panels corresponding to said three different primary colors, respectively, combines said three lights reflected from said three liquid crystal display panels using a prism, and projects said combined three lights through a first lens onto a screen, wherein said optical system comprises: a mirror which reflects a first light of a first one of said three primary colors of said light from said light source, and transmits therethrough second and third lights of second and third ones of said three primary colors of said light from said light source; a first optical component which enters said first light reflected from said mirror into a first one of said three liquid crystal display panels, and then directs said first light reflected from said first one of said three liquid crystal display panels into said prism; and a second optical component which enters said second and third lights transmitted through said mirror into second and third ones of said three liquid crystal display panels, respectively, and then directs said second and third lights reflected from said second and third ones of said three liquid crystal display panels into said prism; and wherein said liquid crystal projector is provided with a second lens disposed between said first optical component and said prism, and a third lens disposed between said second optical component and said prism, and a combination of said second lens, said third lens, said prism and said first lens constitute a projection lens optical system which projects said combined three lights onto said screen.

The present invention is not limited to the above-described configurations, but various changes and modifications can be made without departing from the true spirit and scope of the present invention.

### BRIEF DESCRIPTION OF THE DRAWINGS

In the accompanying drawings, in which like reference numerals designate similar components throughout the figures, and in which:

FIG. 1 illustrates a configuration of an embodiment of a liquid crystal projector in accordance with the present invention including optical paths therein;

FIG. 2(a) illustrates an optical path in a case in which a green light from a green-color liquid crystal display panel passes through a second polarizing beam splitter, and then is projected onto a screen by a projection lens optical system in accordance with an embodiment of the present invention;

FIG. 2(b) is an illustration similar to that of FIG. 2(a), but illustrates an optical path in a case in which a second lens is omitted from the configuration of FIG. 2(a);

FIG. 3(a) is a schematic plan view of an example of a wire grid polarizing beam splitter of a mirror configuration;

FIG. 3(b) is a schematic cross-sectional view of the wire grid polarizing beam splitter shown in FIG. 3(a), taken along line III(b)-III(b);

FIG. 3(c) is a schematic cross-sectional view of the wire grid polarizing beam splitter shown in FIG. 3(a), taken along line III(c)-III(c);

FIG. 4 is a schematic perspective view of an example of a wire grid polarizing beam splitter of a prism configuration; and

FIG. 5 tabulates examples of various combinations of optical components.

### DETAILED DESCRIPTION OF THE PREFERRED EMBODIMENTS

An embodiment of the liquid crystal projector in accordance with the present invention will be explained with reference to the drawings.

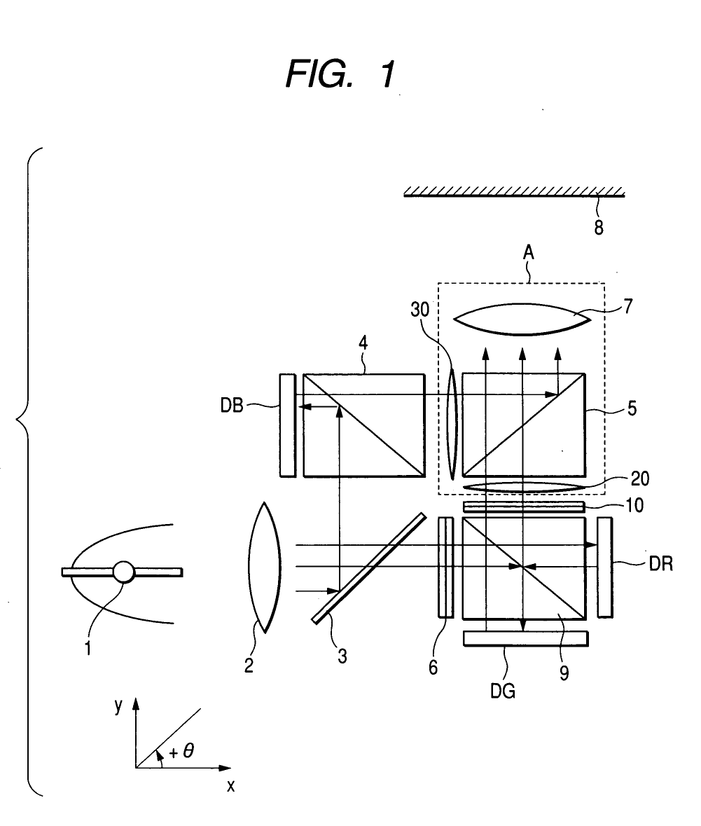

FIG. 1 illustrates a configuration of an embodiment of the liquid crystal projector in accordance with the present invention including optical paths therein.

In a system of rectangular co-ordinates in FIG. 1, a dichroic mirror 3 is spaced from a light source 1 in the positive x direction with an illuminating optical system 2 interposed therebetween. A mirror plane of the dichroic mirror 3 is oriented at 45° to the x axis.

A first polarizing beam splitter 4 is disposed adjacently to the dichroic mirror 3 in the positive y direction with its reflective interface oriented at −45° to the x axis. A blue-color liquid crystal display panel DB for a blue color display is disposed adjacently to the first polarizing beam splitter 4 in the negative x direction. The blue-color liquid crystal display panel DB comprises an envelope formed of a pair of opposing substrates, a liquid crystal layer sandwiched between said pair of opposing substrates, and a large number of pixels arranged in a matrix fashion in a plane parallel with the liquid crystal layer. The respective pixels are configured such that the light transmission of their liquid crystal material layers is controlled based upon pixel signals externally applied to them. One of the pair of opposing substrates is transparent, and the other of the pair is comprised of a semiconductor substrate having miniature electronic circuits fabricated on or within its liquid-crystal-layer-side surface. Here, this blue-color liquid crystal display panel DB is of the so-called reflective type, and reflective films which double as electrodes are provided on the liquid-crystal-layer-side surface of the semiconductor substrate for the respective pixels. Light from the outside is reflected by these reflective films, and then is emitted to the outside again.

A second polarizing beam splitter 9 is disposed adjacently to the dichroic mirror 3 in the positive x direction with its reflective interface oriented at −45° to the x axis. Disposed adjacently to the second polarizing beam splitter 9 are a first phase plate 6 on the dichroic-mirror 3 side of the second polarizing beam splitter 9, a green-color liquid crystal display panel DG for a green color display in the negative y direction, and a red-color liquid crystal display panel DR for a red color display in the positive x direction. Both the green-color liquid crystal display panel DG and the red-color liquid crystal display panel DR are of the same configuration as that of the blue-color liquid crystal display panel DB, and they are driven in the same way as the blue-color liquid crystal display panel DB to produce the same images.

A dichroic prism 5 is disposed above the second polarizing beam splitter 9 in the positive y direction with its reflective interface oriented at 45° to the x axis. A second phase plate 10 is disposed between the second polarizing beam splitter 9 and the dichroic prism 5. Further, a lens 20 is disposed between the second phase plate 10 and the dichroic prism 5, and a lens 30 is disposed between the first polarizing beam splitter 4 and the dichroic prism 5. A projection lens 7 is disposed above the dichroic prism 5 in the positive y direction.

Here, the lens 20, the lens 30, the dichroic prism 5 and the projection lens 7 are combined to constitute a projection lens optical system represented by a block indicated by broken lines in FIG. 1. This projection lens optical system can be treated as an optical system independent of other optical components such as the first polarizing beam splitter 4 or the like, and its functions will be explained subsequently.

In the liquid crystal projector having the above optical system, light from the light source 1 entered into the illuminating optical system 2 is collimated and produces so-called s-polarized light having a homogenized distribution. The light from the illuminating optical system 2 enters the dichroic mirror 3, then a blue light LB of the light is reflected at 90° from the x axis, and the remainder of the light is transmitted. After having changed its optical path, the blue light LB enters the first polarizing beam splitter 4, then changes its optical path through an angle of 90° and enters the blue-color liquid crystal display panel DB.

The reflected light from the blue-color liquid crystal display panel DB passes through the first polarizing beam splitter 4, then passes through the lens 30, and enters the dichroic prism 5. The dichroic prism 5 is configured so as to change the optical path of the blue light LB into a direction at an angle of 90° with respect to the x axis, and to pass a red light LR and a green light LG therethrough.

The blue light LB entered into the dichroic prism 5 is directed toward the projection lens 7 by the dichroic prism 5, and then is emitted as an emergent light from the liquid crystal projector. The blue light LB emitted from the liquid crystal projector is projected onto a screen 8 disposed at a distance from the liquid crystal projector.

The yellow light having passed through the dichroic mirror 3 passes through the first phase plate 6, and is split into the green light LG and the red light LR by the first phase plate 6. The first phase plate 6 rotates the direction of polarization of wavelengths in the region of red only through 90°.

The red light LR enters the second polarizing beam splitter 9, passes through it without appreciable changes, then enters the red-color liquid crystal display panel DR, then is reflected by the red-color liquid crystal display panel DR, and then enters the second polarizing beam splitter 9 again.

The path of the red light LR modulated by the liquid crystal of the red-color liquid crystal display panel DR is changed by an angle of 90° with respect to the x axis by the second polarizing beam splitter 9, and then the direction of the polarization of the red light LR is rotated through 90° by the second phase plate 10, and then the red light LR passes through the lens 20, and then passes through the dichroic prism 5 without appreciable changes. The red light LR having passed through the dichroic prism 5 is combined with the already explained blue light LB, and then is projected onto the screen 8 via the projection lens 7.

The green light LG passes through the first phase plate 6 without appreciable changes, then its path is changed by an angle of −90° with respect to the x axis by the second polarizing beam splitter 9, then the green light LG enters the green color liquid crystal display panel DG, then is reflected by the liquid crystal display panel DG, and then enters the second polarizing beam splitter 9. The green light LG reflected by the green color liquid crystal display panel DG has been modulated by the green color liquid crystal display panel DG, then passes through the second polarizing beam splitter 9, then passes through the second phase plate 10, passes through the lens 20, and passes through the dichroic prism 5. The green light LG passing through the dichroic prism 5 is combined with the already described blue and red lights LB, LR, and then is projected onto the screen 8 via the projection lens 7.

In the liquid crystal projector of the above configuration, a combination of a first lens 30 through which the blue light passes, the dichroic prism 5 and the projection lens 7, or a combination of a second lens 20 through which the green and red lights pass, the dichroic prism 5 and the projection lens 7 can be treated as an optical system independent of other optical components as described above, and each of the combinations will be referred to as the projection lens optical system A.

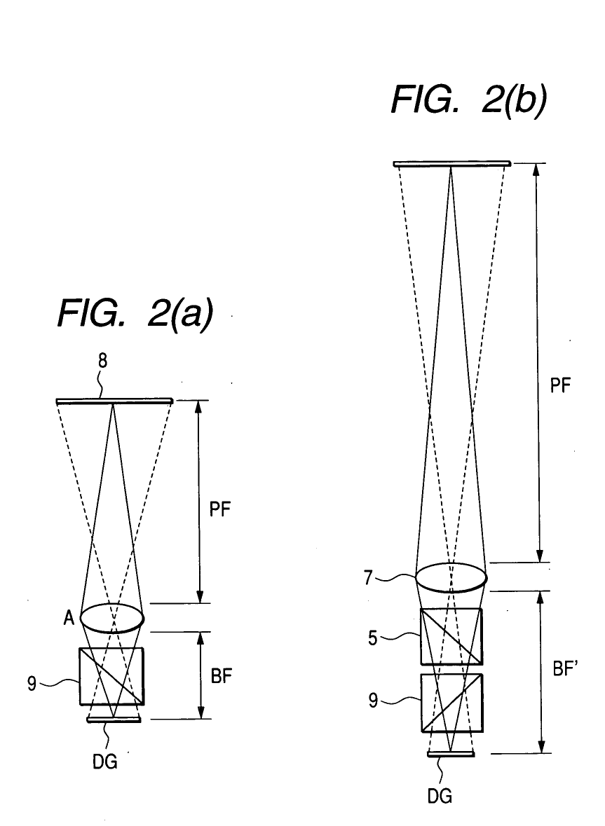

FIG. 2(a) illustrates an optical path in a case in which the green light from the green-color liquid crystal display panel DG, for example, passes through the second polarizing beam splitter 9, and then is projected onto the screen 8 by the projection lens optical system A. The projection lens optical system A in this case is represented as a single equivalent lens, but, as explained above, it is comprised of the second lens 20, the dichroic prism 5 and the projection lens 7.

Although FIG. 2(b) is an illustration similar to that of FIG. 2(a), for purposes of comparison FIG. 2(b) illustrates an optical path in a case in which the second lens 20 is omitted. In this case, the first lens 30 (not included in the configuration of FIG. 2(a)) is also omitted.

In the case illustrated in FIG. 2(a), the second polarizing beam splitter 9 is interposed between the projection lens optical system A and the green-color liquid crystal display panel DG, but the dichroic prism 5 is not interposed between them. The dichroic prism 5 can be considered as part of the projection lens optical system A because the second lens 20 is provided at the entrance side of the dichroic prism 5 as explained above. This means that the back focal length BF of the projection lens optical system A can be selected to be approximate to the width of the second polarizing beam splitter 9 regardless of the presence of the dichroic prism 5.

On the other hand, in the case illustrated in FIG. 2(b), because of the absence of the second lens 20 at the entrance side of the dichroic prism 5, the second polarizing beam splitter 9 and the dichroic prism 5 are interposed between the projection lens 7 and the green-color liquid crystal display panel DG, and consequently, the back focal length BF′ of the projection lens 7 is approximate to the sum of the widths of the second polarizing beam splitter 9 and the dichroic prism 5, and consequently, the back focal length BF′ needs to be selected to be greater than that in the case illustrated in FIG. 2(a).

As explained above, the configurations of this embodiment are capable of reducing the back focal length of the projection lens optical system A, and consequently, this embodiment provides an advantage that can reduces the size of the lens of the projection lens optical system A. Since the magnifying power of the projection lens optical system A is increased, this embodiment also provides an advantage of making shorter a projection distance PF between the projection lens optical system A and the screen 8 for the screen 8 of the same size. This makes it possible to realize the reduction of the thickness of a rear projection type TV receiver, for example.

Further, while the configuration illustrated in FIG. 1 employs the optical components such as the first polarizing beam splitter 4, the second polarizing beam splitter 9 and the dichroic prism 5, a wire grid polarizing beam splitter of a mirror configuration and a wire grid polarizing beam splitter of a prism configuration can be employed as the optical components instead of them, and in this case also the same advantages as those explained above can be provided.

The configurations and functions of the respective optical components are as follows:

Polarizing Beam Splitter (Hereinafter Sometimes Referred to as PBS)

A polarizing beam splitter has a prism configuration, and its beam splitting interface is comprised of a multilayer film. The polarizing beam splitter has a function of reflecting an s-polarized light and transmitting a p-polarized light. Its polarizing beam splitting efficiency is highly dependent upon an incidence angle of light, and is degraded as the incidence angle becomes wider. Further, the polarizing beam splitter exhibits a phenomenon of rotating the plane of polarization of obliquely incident light.

Dichroic Prism

A dichroic prism has a prism configuration, and its beam splitting interface is comprised of a multilayer film. The dichroic prism has a function of reflecting light in a specified wavelength range and transmitting light in other wavelength ranges.

Wire Grid Polarizing Beam Splitter of a Mirror Configuration

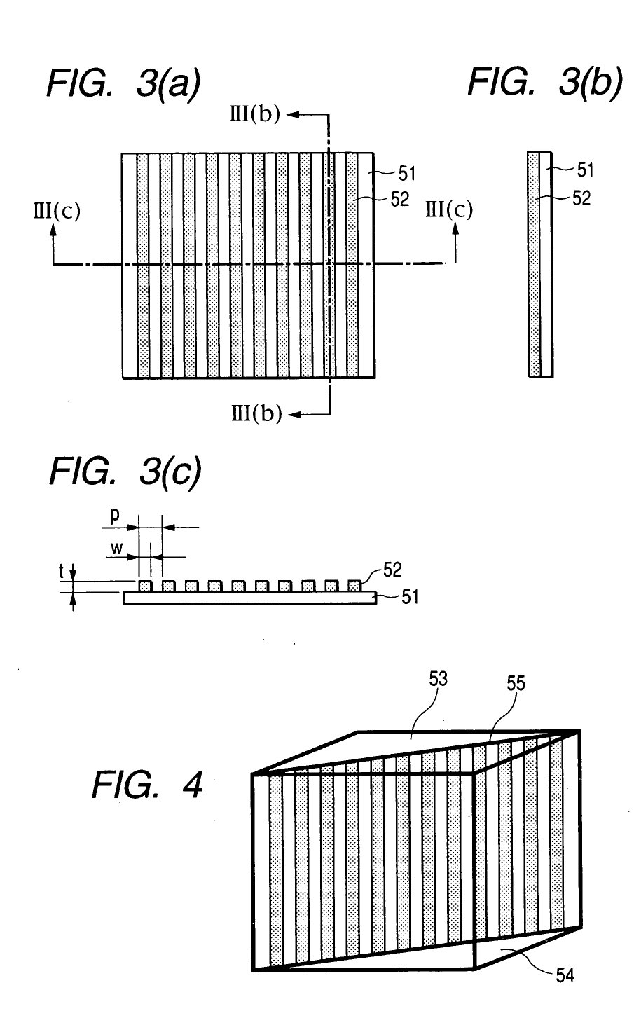

FIG. 3(a) is a schematic plan view of an example of a wire grid polarizing beam splitter of a mirror configuration, FIG. 3(b) is a schematic cross-sectional view of the wire grid polarizing beam splitter shown in FIG. 3(a), taken along line III(b)-III(b), and FIG. 3(c) is a schematic cross-sectional view of the wire grid polarizing beam splitter shown in FIG. 3(a), taken along line III(c)-III(c). The wire grid polarizing beam splitter of a mirror configuration has a planar mirror structure, and its beam splitting surface is comprised of an aluminum film 52 evaporated on a substrate 51 and patterned in the form of wires arranged with a pitch much less than the wavelengths of light of the visible spectrum.

The wire grid polarizing beam splitter may be of the type having dimensions similar to those described in U.S. Pat. Nos. 6,243,199 B1 and 6,234,634B1 issued to Hansen et al. on Jun. 5, 2001 and May 22, 2001, respectively. These Hansen et al. patents are incorporated by reference herein for the purpose of disclosure.

U.S. Pat. No. 6,234,634 B1 discloses the following dimensions for the configuration shown in FIG. 3(a).

The pitch p of the wire arrangement must fall under approximately 0.21 μm to produce a beam splitter which has reasonable performance throughout the visible spectrum.

The wire thickness t must be between about 0.04 μm and 0.5 μm.

The ratio of the wire width w to the wire pitch p must fall within the ranges of from approximately 0.3 to 0.76.

The wire grid polarizing beam splitter of the mirror configuration has a function of reflecting an s-polarized light and transmitting a p-polarized light. Its polarizing beam splitting efficiency is less dependent upon an incidence angle of light, and the wire grid polarizing beam splitter of the mirror configuration does not exhibit a phenomenon of rotating the plane of polarization of obliquely incident light.

Wire Grid Polarizing Beam Splitter of a Prism Configuration

FIG. 4 is a schematic perspective view of an example of a wire grid polarizing beam splitter of a prism configuration. This type of the beam splitter includes a pair of prisms 53, 54 having sandwiched therebetween a beam splitting interface 55 similar to the beam splitting surface explained in connection with FIGS. 3(a) to 3(c).

The wire grid polarizing beam splitter of the prism configuration operates on a principle similar to that for the above-explained wire grid polarizing beam splitter of the mirror configuration, and has much the same function as that of the above-explained wire grid polarizing beam splitter of the mirror configuration. The reason for this configuration is that, in a case where an inclined glass plate is interposed between a liquid crystal display panel and a projection lens, aberration is produced, and therefore the prism configuration is employed to prevent occurrence of the aberration.

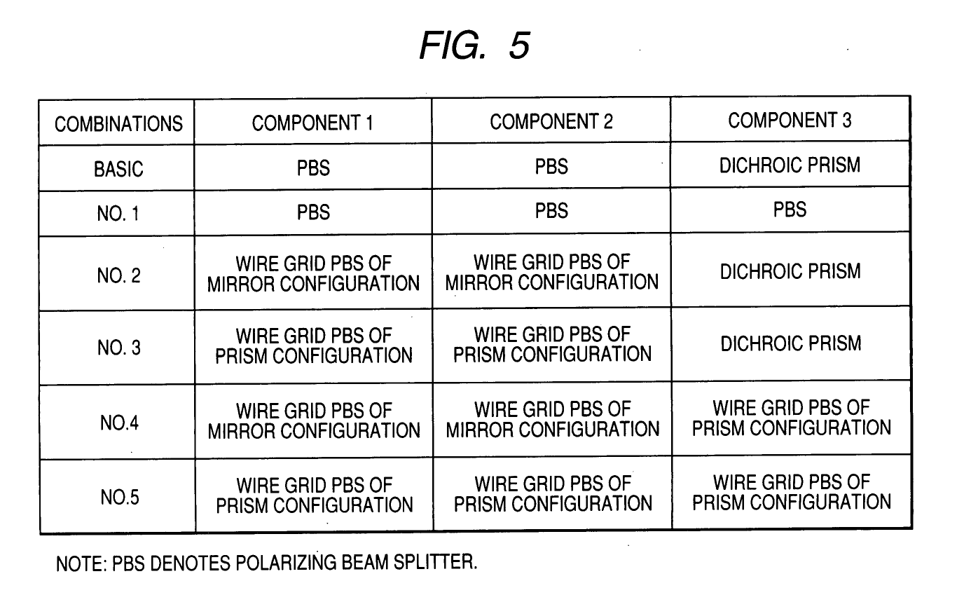

Examples of various combinations of the above-described optical components are tabulated in FIG. 5. In this table, COMPONENT 1 represents a component corresponding to the first polarizing beam splitter 4 in FIG. 1, COMPONENT 2 represents a component corresponding to the second polarizing beam splitter 9 in FIG. 1, and COMPONENT 3 represents a component corresponding to the dichroic prism 5 in FIG. 1. In the following the combinations described in FIG. 5 will be explained. A COMBINATION labeled “BASIC” in FIG. 5 corresponds to the combination illustrated in FIG. 1.

COMBINATION 1

A polarizing beam splitter is used as COMPONENT 1, a polarizing beam splitter is used as COMPONENT 2, and a polarizing beam splitter is used as COMPONENT 3. In this case, light from a liquid crystal display panel passes through two polarizing beam splitters, and thereby the degree of polarization is improved, and consequently, the contrast ratio provided by the optical system is increased.

COMBINATION 2

A wire grid polarizing beam splitter of the mirror configuration is used as COMPONENT 1, a wire grid polarizing beam splitter of the mirror configuration is used as COMPONENT 2, and a dichroic prism is used as COMPONENT 3. In this case, the wire grid polarizing beam splitters of the mirror configuration are used as both COMPONENT 1 and COMPONENT 2, and consequently, the contrast ratio provided by the optical system is increased.

COMBINATION 3

A wire grid polarizing beam splitter of the prism configuration is used as COMPONENT 1, a wire grid polarizing beam splitter of the prism configuration is used as COMPONENT 2, and a dichroic prism is used as COMPONENT 3. In this case, the wire grid polarizing beam splitters of the prism configuration are used as both COMPONENT 1 and COMPONENT 2, and consequently, the contrast ratio provided by the optical system is increased, and astigmatism is eliminated compared with COMBINATION 2.

COMBINATION 4

A wire grid polarizing beam splitter of the mirror configuration is used as COMPONENT 1, a wire grid polarizing beam splitter of the mirror configuration is used as COMPONENT 2, and a wire grid polarizing beam splitter of the prism configuration is used as COMPONENT 3. In this case, the wire grid polarizing beam splitters of the prism configuration are used as both COMPONENT 1 and COMPONENT 2, and therefore the degree of polarization is improved, and consequently, the contrast ratio provided by the optical system is increased.

COMBINATION 5

A wire grid polarizing beam splitter of the prism configuration is used as COMPONENT 1, a wire grid polarizing beam splitter of the prism configuration is used as COMPONENT 2, and a wire grid polarizing beam splitter of the prism configuration is used as COMPONENT 3. In this case, and the contrast ratio provided by the optical system is increased, and astigmatism is eliminated compared with COMBINATION 4.

1. A liquid crystal projector which splits light from a light source into three lights of three different primary colors, respectively, through an optical system, enters said three lights into three liquid crystal display panels corresponding to said three different primary colors, respectively, combines said three lights reflected from said three liquid crystal display panels using a prism, and projects said combined three lights through a first lens onto a screen,
wherein said liquid crystal projector is provided with two second lenses each of which is disposed at a respective one of two entrance sides of said prism on which said three reflected lights are incident, and a combination of said two second lenses, said prism and said first lens constitute a projection lens optical system which projects said combined three lights onto said screen.

2. A liquid crystal projector which splits light from a light source into three lights of three different primary colors, respectively, through an optical system, enters said three lights into three liquid crystal display panels corresponding to said three different primary colors, respectively, combines said three lights reflected from said three liquid crystal display panels using a prism, and projects said combined three lights through a first lens onto a screen,
wherein said optical system comprises:
a mirror which reflects a first light of a first one of said three primary colors of said light from said light source, and transmits therethrough second and third lights of second and third ones of said three primary colors of said light from said light source;
a first optical component which enters said first light reflected from said mirror into a first one of said three liquid crystal display panels, and then directs said first light reflected from said first one of said three liquid crystal display panels into said prism; and
a second optical component which enters said second and third lights transmitted through said mirror into second and third ones of said three liquid crystal display panels, respectively, and then directs said second and third lights reflected from said second and third ones of said three liquid crystal display panels into said prism; and
wherein said liquid crystal projector is provided with a second lens disposed between said first optical component and said prism, and a third lens disposed between said second optical component and said prism, and a combination of said second lens, said third lens, said prism and said first lens constitute a projection lens optical system which projects said combined three lights onto said screen.

3. A liquid crystal projector according to claim 2, wherein said first optical component is a polarizing beam splitter, said second optical component is a polarizing beam splitter, and said prism is a dichroic prism.

4. A liquid crystal projector according to claim 2, wherein said first optical component is a polarizing beam splitter, said second optical component is a polarizing beam splitter, and said prism is a polarizing beam splitter.

5. A liquid crystal projector according to claim 2, wherein said first optical component is a wire grid polarizing beam splitter of a mirror configuration, said second optical component is a wire grid polarizing beam splitter of a mirror configuration, and said prism is a dichroic prism.

6. A liquid crystal projector according to claim 2, wherein said first optical component is a wire grid polarizing beam splitter of a prism configuration, said second optical component is a wire grid polarizing beam splitter of a prism configuration, and said prism is a dichroic prism.

7. A liquid crystal projector according to claim 2, wherein said first optical component is a wire grid polarizing beam splitter of a mirror configuration, said second optical component is a wire grid polarizing beam splitter of a mirror configuration, and said prism is a wire grid polarizing beam splitter of a prism configuration.

8. A liquid crystal projector according to claim 2, wherein said first optical component is a wire grid polarizing beam splitter of a prism configuration, said second optical component is a wire grid polarizing beam splitter of a prism configuration, and said prism is a wire grid polarizing beam splitter of a prism configuration.
